(19) United States
(12) Patent Application Publication
(10) Pub. No.: US 2008/0144588 A1
(43) Pub. Date: Jun. 19, 2008

(54) Method and apparatus of prioritizing services of wireless local area network

(76) Inventors: Amir Mezer, Haifa (IL); Amit Barak, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/638,688

(22) Filed: Dec. 14, 2006

(51) Int. Cl. H04Q 7/24

(52) U.S. Cl. 370/338

(57) ABSTRACT

A wireless communication device and a method and of prioritizing services in a wireless local area network is provided. The method includes defining a first priority of a first service of a first basic service set of a wireless local area network and defining a second priority of a second service of a second basic service set of the wireless local area network, wherein the first priority is different from the second priority.

### BACKGROUND OF THE INVENTION

Wireless local area networks (WLAN) may include a basic service set (BSS). The BSS may include an access point (AP) and one or more stations (ST). The stations of the BSS may also be referred as nodes. An infrastructure WLAN, may include two or more APs. An AP of the two or more APs may establish one or more BSSs and may serve each BSS with the same priority. According to a standard issued by an Institute of Electrical & Electronics Engineers (IEEE), e.g. IEEE P802.11-REVma/D5.0, the BSS is identified by a Service Set Identifier (SSID) and a BSS Identifier (BSSID). For example the AP may send a beacon with two SSIDs, an Office WLAN identifier and a Guest WLAN identifier. The two or more BSSs of the infrastructure WLAN are provided with the same priority to the different services. Thus, the services may interfere each other.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention;

FIG. 2 is a schematic illustration of a block diagram of an access point (AP) according to exemplary embodiments of the invention; and

FIG. 3 is a schematic illustration of a flowchart of a method of allocating priorities to a basic service set of a wireless communication network according to some exemplary embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, or transmission devices.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

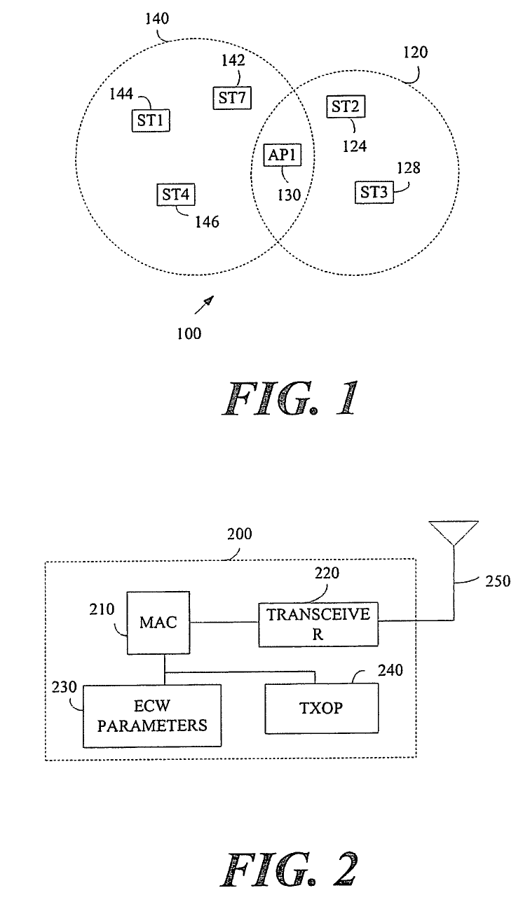

Turning first to FIG. 1, an illustration of a wireless communication system, for example, a WLAN 100 is shown. Although the scope of the present invention is not limited in this respect, WLAN 100 may be defined, by IEEE 802.11-1999 standard, as an Extended Service Set (ESS). For example, the ESS may include BSS 120 and BSS 140 and an AP 130, if desired. According to one exemplary embodiment of the invention, BSS 120 may include stations 124 and 128 and BSS 140 may include stations 142, 144 and 146. According to this exemplary embodiment of the present invention, AP 130 may provide services having different priorities to BSS 120 and BSS 140. For example, BSS 120 may include a guest BSS having a low priority, and BSS 140 may include an Office BSS having a high priority.

According to some embodiments of the present invention, an allocation of different priorities to BSSs of WLAN 100 may be done by assigning different parameters to BSSs 120 and 140 based on IEEE P802.11-REVma/D5.0 standard. More specifically, Enhanced Distributed Channel Access (EDCA) parameters may be assigned to BSSs 120 and 140, if desired.

According to IEEE P802.11-REVma/D5.0 standard, EDCA parameters may include Element ID, Length, Quality of Service (QoS) information and access category (AC) parameters for Best Effort (AC_BE), Background (AC_BK), Video (AC_VI) and Voice (AC_VO). The AC parameters may include, a contention window minimum and maximum length (e.g., ECWₘᵢₙ and ECWₘₐₓ) and a transmit opportunity limitation (e.g., TXOP_{Limit}). Stations of BSS 120 and/or BSS 140 may gain access to WLAN 100 according to the contention window parameters and TXOP parameter, if desired.

According to one exemplary embodiment of the invention, setting different priority to BSS 120 and/or BSS 140 may be done by assign a different set of EDCA parameters to BSS 120 and/or BSS 140, respectively. According to other embodiments of the present invention, the assignment of different priorities to BSS 120 and 140 may be done by assign different ECWₘᵢₙ, and TXOP Limit values to BSSs 120 and 140 as is shown by table 1 below.

For example, the ECWₘᵢₙ is a value which represents the minimum size of the contention window for drawing the backoff time. The lower the value, the higher the priority. The TXOP Limit is a value used after the media access has been gained and depicts how long the station may continue of transmitting. The larger the value of TXOP Limit, the higher the priority. According to table 1, in order to set the highest priority to the Secure Office BSS (e.g, BSS 120) the ECWₘᵢₙ may be set to a low value and TXOP_{Limit} may be set to a high value. In non-secure guest BSS (e.g., BSS 140) the ECWₘᵢₙ may be set to a high value and TXOP_{Limit} may be set to a low value, although the scope of the present invention is not limited to this example.

TABLE 1

| BSS Service (Priority) | ECWmin | TXOP Limit |
|---|---|---|
| Secure Office (Highest) | Low | High |
| Non-secure Guest (Lowest) | High | Low |

Turning to FIG. 2, a schematic illustration of a block diagram of an access point (AP) 200 according to exemplary embodiments of the invention is shown. Although the scope of the present invention is not limited to this exemplary embodiment of the invention, AP 200 may include a medium access controller 210 to control an access of stations of a BSS to a wireless medium. MAC 210 may set priorities to different BSSs either by setting different EDCA parameters to each BSS (e.g., BSS 120 and/or BSS 140), according to one embodiment of the invention or, by setting different ECW parameters 230 and/or different TXOP 240 to each BSS (e.g., BSS 120 and/or BSS 140), according to another embodiment of the invention.

Transceiver 220 may transmit through an antenna 250, a beacon with the set of parameters in order to set different priorities to the different stations of the different BSSs. Antenna 250 may include a dipole antenna, a Yagi antenna, an antenna array, two or more antennas or the like. It should be understood that the described blocks and/or components of AP 200 may be implemented by hardware, by software and/or by any combination of hardware and software.

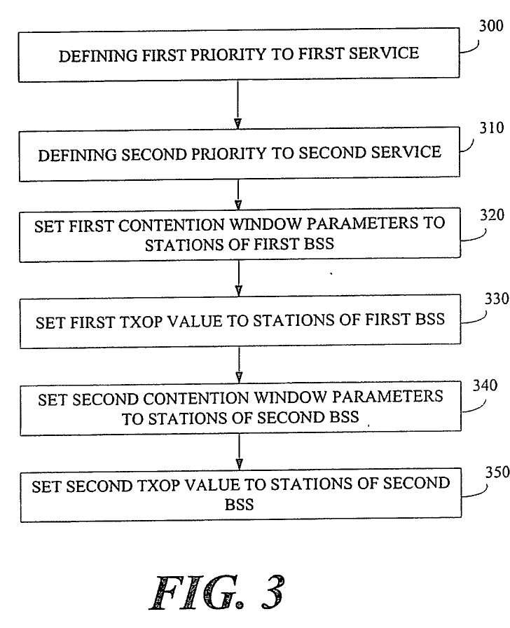

Turning to FIG. 3 a schematic illustration of a flowchart of a method of allocating priorities to a basic service set of a wireless communication network according to some exemplary embodiment of the present invention is shown. According to this exemplary method, MAC 210 is capable of defining a first priority of a first service of a first basic service set of the wireless local area network (text block 300) and defining a second priority of a second service of a second basic service set of the wireless local area network, wherein the first priority is different from the second priority (text block 310).

According to one embodiment of the invention MAC 210 may set the priorities to first and second services provided by the first and second BSSs, respectively. MAC 210 may set the priorities by setting a first contention window value based on the first priority of the first service (text block 320) and a second contention window value based on the second priority of second service (text block 330). In addition, MAC 210 may set the priorities to first and second BSSs by setting a first transmit opportunity value base on the priority of the first service (text block 340) and setting a second transmit opportunity value base on the priority of the second service (text block 350).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method of prioritizing services of a wireless local-area network comprising:
providing first and second services by a single access point;
defining a first priority of a first service of a first basic service set of the wireless local area network; and
defining a second priority of a second service of a second basic service set of the wireless local area network, wherein the first priority is different from the second priority.

2. The method of claim 1, comprising:
setting a first contention window value based on the first priority of the first service; and
setting a second contention window value based on the second priority of second service.

3. The method of claim 1, comprising:
setting a first transmit opportunity value base on the priority of the first service; and
setting a second transmit opportunity value base on the priority of the second service.

4. The method of claim 2, comprising:
setting the first contention window value to one or more stations of the first basic service set; and
setting the second contention window value to one or more the stations of the second basic service set.

5. The method of claim 3, comprising:
setting the first transmit opportunity value to one or more stations of the first basic service set; and
setting the second transmit opportunity value to one or more to the stations of the second basic service set.

6. A wireless communication device comprising:
A medium access controller to define a first priority of a first service of a first basic service set of a wireless local area network and to define a second priority of a second service of a second basic service set of the wireless local area network, wherein the first priority is different from the second priority.

7. The wireless communication device of claim 6, wherein the medium access controller is configured to set a first contention window value based on the first priority of the first service and a second contention window value based on the second priority of second service.

8. The wireless communication device of claim 6, wherein the medium access controller is configured to set a first transmit opportunity value base on the priority of the first service and to set a second transmit opportunity value base on the priority of the second service.

9. The wireless communication device of claim 7, wherein the medium access controller is configured to set the first contention window value to one or more stations of the first basic service set and the second contention window value to one or more the stations of the second basic service set.

10. The wireless communication device of claim 8, wherein the medium access controller is configured to set the first transmit opportunity value to one or more stations of the first basic service set and to set the second transmit opportunity value to one or more the stations of the second basic service set.

11. A wireless communication device comprising:
A medium access controller to define a first priority of a first service of a first basic service set of a wireless local area network and to define a second priority of a second service of a second basic service set of the wireless local area network, wherein the first priority is different from the second priority; and
a dipole antenna to transmit signals provided by the first and second service based on the first and second priorities.

12. The wireless communication device of claim 11, wherein the medium access controller is configured to set a first contention window value based on the first priority of the first service and a second contention window value based on the second priority of second service.

13. The wireless communication device of claim 11, wherein the medium access controller is configured to set a first transmit opportunity value base on the priority of the first service and to set a second transmit opportunity value base on the priority of the second service.

14. The wireless communication device of claim 12, wherein the medium access controller is configured to set the first contention window value to one or more stations of the first basic service set and the second contention window value to one or more the stations of the second basic service set.

15. The wireless communication device of claim 13, wherein the medium access controller is configured to set the first transmit opportunity value to one or more stations of the first basic service set and to set the second transmit opportunity value to one or more the stations of the second basic service set.

16. A wireless local area network comprising:
a first basic service set including one or more stations;
a second basic service set including one or more stations; and
an access point to provide first and second service to the first and second basic service set, respectively and wherein the access point comprises:
a medium access controller to define a first priority of the first service of the first basic service set and to define a second priority of the second service of the second basic service set, wherein the first priority is different from the second priority.

17. The wireless local area network of claim 16, wherein the medium access controller is configured to set a first contention window value based on the first priority of the first service and a second contention window value based on the second priority of second service.

18. The wireless local area network of claim 16, wherein the medium access controller is configured to set a first transmit opportunity value base on the priority of the first service and to set a second transmit opportunity value base on the priority of the second service.

19. The wireless local area network of claim 17, wherein the medium access controller is configured to set the first contention window value to one or more stations of the first basic service set and the second contention window value to one or more the stations of the second basic service set.

20. The wireless local area network of claim 18, wherein the medium access controller is configured to set the first transmit opportunity value to one or more stations of the first basic service set and to set the second transmit opportunity value to one or more the stations of the second basic service set.
